(19) United States
(12) Patent Application Publication
(10) Pub. No.: US 2009/0315712 A1
(43) Pub. Date: Dec. 24, 2009

(54) SURVEILLANCE METHOD AND SYSTEM USING OBJECT BASED RULE CHECKING

(75) Inventors: Mark Bloemendaal, Heteren (NL); Jelle Foks, Melbourne, FL (US); Johannes Steensma, Melbourne, FL (US); Eric Lammerts, Melbourne, FL (US)

Correspondence Address: YOUNG & THOMPSON, 209 Madison Street, Suite 500, Alexandria, VA, 22314, US

(73) Assignee: ULTRAWAVE DESIGN HOLDING B.V., Heteren (NL)

(21) Appl. No.: 12/307,035

(22) PCT Filed: Jun. 30, 2006
(86) PCT No.: PCT/NL06/50160

§ 371 Date: Mar. 30, 2009

(51) Int. Cl. G08B 13/196

(52) U.S. Cl. 340/541

(57) ABSTRACT

Surveillance method and system for monitoring a location. One ore more sensors, e.g. camera's, are used to acquire sensor data from the location. The sensor data is processed in order to obtain an extracted object list, including object attributes. A number of virtual objects, such as a virtual fence, are defined, and a rule set is applied. The rule set defines possible responses depending on the list of extracted objects and the virtual objects. Rule sets may be adapted, and amended responses may be assessed immediately.

### FIELD OF THE INVENTION

The present invention relates to a surveillance method for monitoring a location, comprising acquire sensor data from at least one sensor and process sensor data from the at least one sensor. Furthermore, the present invention relates to a surveillance system.

### PRIOR ART

Such a method and system are e.g. known from American patent application US2003/0163289, which describes an object monitoring system comprising multiple camera's and associated processing units. The processing units process the video data originating from the associated camera and data from further sensors, and generates trigger signals relating to a predetermined object under surveillance. A master processor is present comprising agents which analyze the trigger signals for a specific object and generate an event signal. The event signals are monitored by an event system, which determines whether or not an alarm condition exists based on the event signals. The system is particularly suited to monitor static objects, such as paintings and artworks in a museum, and e.g. detect the sudden disappearance (theft) thereof.

### SUMMARY OF THE INVENTION

The present invention seeks to provide a surveillance method and system with improved performance, especially alleviating or eliminating the disadvantages of the prior art methods and systems as mentioned above.

According to the present invention, a surveillance method according to the preamble defined above is provided, in which the sensor data is processed in order to obtain an extracted object list, to define at least one virtual object, and to apply at least one rule set, the at least one rule set defining possible responses depending on the extracted object list and the at least one virtual object. The virtual object is e.g. a virtual fence referenced to the sensor data characteristic (e.g. a box or line in video footage), but may also be of a different nature, e.g. the sound of a breaking glass window. The applying of rules may result in a response, e.g. generating a warning. It is noted that in the present invention, the extracted object list comprises all objects in a sensor data stream, e.g. all objects extractable from a video data stream. This as opposed to prior art systems, where only objects in a predefined region-of-interest are extracted (thus loosing information) or other systems, where only objects which generate a predefined event are extracted and further processed (e.g. tracked).

In a further embodiment, the extracted object list is updated depending on the update rate of the at least one sensor. This allows to dynamic application of the rule set, in which instant action can be taken when desired or needed.

The extracted object list may be stored in a further embodiment, and the at least one rule set may then be applied later in time. This allows to define a rule set depending on what is actually searched, which is advantageously for research and police work, e.g. when re-assessing a recorded situation. This embodiment also allows to adapt a rule set and immediate rerun the analysis to check for improved response.

In a further embodiment, the at least one rule set comprises multiple, independent rule sets. This allows to use the surveillance method in a multi-role fashion, in parallel operation (i.e. in real-time if needed).

Processing sensor data comprises in a further embodiment determining for each extracted object in the extracted object list associated object attributes, such as classification, color, texture, shape, position, velocity. When other types of sensors are used, the object attributes may be different, e.g. in the case of audio sensors, the attributed may include frequency, frequency content, amplitude, etc.

Obtaining the extracted object list may comprise consecutive operations of data enhancement (e.g. image enhancement), object finding, object analysis and object tracking. As a result, an extracted object list is obtained, which may be used further in the present method.

In a further embodiment, the sensor data comprises video data, and the data enhancement comprises one or more of the following data operations: noise reduction; image stabilization; contrast enhancement. These are all preliminary steps, which aid in the further object extraction process of the present method.

Object finding in a further embodiment of the present method comprises one or more of the group of data operations comprising: edge analysis, texture analysis; motion analysis; background compensation. Object analysis comprises one or more of the group of data operations comprising: colour analysis, texture analysis; form analysis; object correlation. Object correlation may include classification of an object (human, vehicle, aircraft, . . . ) with a percentage score representing the likelihood that the object is correctly classified. Object tracking may comprise a combination of identity analysis and trajectory analysis.

In a further aspect, the present invention relates to a surveillance system comprising at least one sensor and a processing system connected to the at least one sensor, in which the processing system is arranged to execute the surveillance method according to any one of the present method embodiments.

The processing system, in a further embodiment, comprises a local processing system located in the vicinity of the at least one sensor, and a central processing system, located remotely from the at least one sensor, and in which the local processing system is arranged to send the extracted object list (with annotations) to the central processing system. In this embodiment, only a low data rate transmission is needed between the local processing system and the central processing system, which allows to use many sensor in the surveillance system. Furthermore, it allows to use wireless network implementations, making the surveillance system much more flexible.

In a further embodiment, the local processing system further comprises a storage device for storing raw sensor data or preprocessed sensor data. Advantageously, in the case of video sensors, a lossless video coding technique is used (or a high quality compression technique, e.g. MPEG4 coding). This allows to retrieve the original camera footage for later use.

The present surveillance system may in an embodiment further comprise at least one operator console arranged for controlling the surveillance system. In a further embodiment, the at least one operator console comprises a representation device, which is arranged to represent simultaneously the sensor data, objects from the extracted object list and at least one virtual object in overlay. This overlay may be used in live monitoring using the present surveillance system, but also in a post-processing mode of operation, e.g. when fine-tuning the rule sets.

### SHORT DESCRIPTION OF DRAWINGS

The present invention will be discussed in more detail below, using a number of exemplary embodiments, with reference to the attached drawings, in which

FIG. 1 shows a schematic view of a surveillance system according to an embodiment of the present invention;

FIG. 2 shows a schematic view of a surveillance system according to a further embodiment of the present invention;

FIG. 3 shows a schematic view of the processing flows according to an embodiment of the present surveillance method;

FIG. 4 shows a schematic view in more detail of a part of the flow diagram of FIG. 3;

FIG. 5 shows a schematic view in more detail of a further part of the flow diagram of FIG. 3;

FIG. 6 shows a schematic view in more detail of a further part of the flow diagram of FIG. 3;

FIG. 7 shows a schematic view in more detail of a further part of the flow diagram of FIG. 3;

FIG. 8 shows a schematic view of the processing steps in the live rule checking embodiment of the present method;

FIG. 9 shows a schematic view of the processing steps in the post-processing rule checking embodiment of the present method;

FIG. 10 shows a view of a first application of the present method to detect intruders;

FIG. 11 shows a view of a second application of the present method to monitor an aircraft platform;

FIG. 12 shows a view of a third application of the present method relating to traffic management.

### DETAILED DESCRIPTION OF EXEMPLARY EMBODIMENTS

According to the present invention, a surveillance method and system are provided for monitoring a location (or group of locations), in which use can be made of multi-sensor arrangements, distributed or centralized intelligence. The implemented method is object oriented, allowing transfer of relevant data at real time while requiring only limited bandwidth resources.

The present invention may be applied in monitoring systems, guard systems, surveillance systems, sensor research systems, and other systems which allow to provide detailed information on scenery in an area to be monitored.

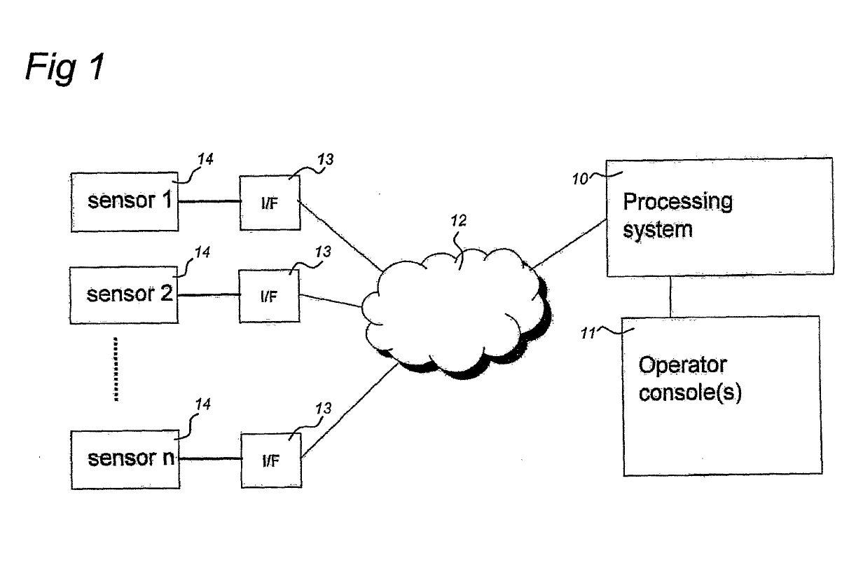

A schematic diagram of a centralized embodiment of such a system is shown in FIG. 1. A number of sensors 14 are provided, which are interfaced to a network 12 using dedicated interface units 13. Furthermore, a central processing system 10 is connected to the network 12, and to one or more operator consoles 11, equipped with input devices (keyboard, mouse, etc.) and displays as known in the art. The network 12 may be a dedicated or an ad-hoc network, and may be wired, wireless, or a combination of both. The processing system 10 comprises the required interfacing circuitry, and one or more processors, such as CPU's, DSP's, etc, and associated devices, such as memory modules, which as such are known to the person skilled in the art.

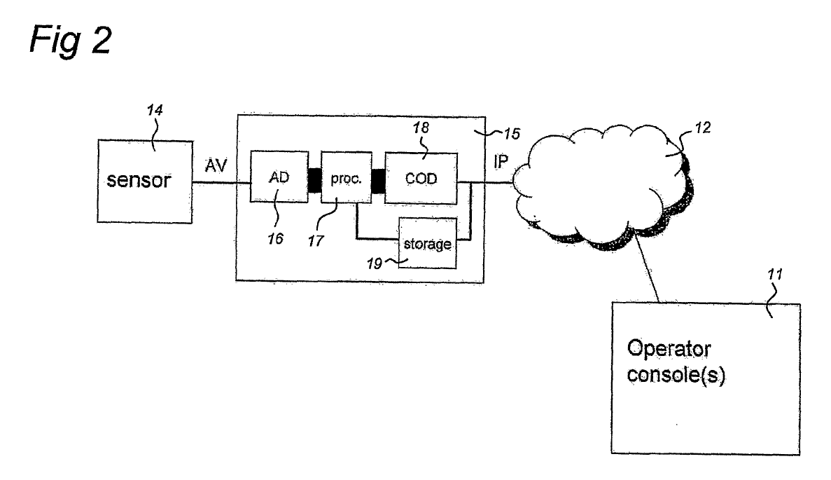

In an alternative embodiment, shown schematically in FIG. 2, a distributed embodiment of the intelligence of a surveillance system is shown. In this embodiment, the sensor 14 is connected to a local processing system 15, which interfaces to the network 12. In this case, the one or more operator console(s) 11 may be directly interfaced to the network 12. Multiple sensors 14 and associated local processing system 15 may be present in an actual surveillance system. For the skilled person it will be clear that other embodiments are possible, e.g. in which the operator console(s) 11 are connected to the network 12 via a central processing system (not shown, but similar to processing system 10 of the embodiment of FIG. 1).

The local processing system 15 comprises a signal converter 16, e.g. in the form of an analog to digital converter, which converts the analog signal(s) from the sensor 14 into a digital signal when necessary. Processing of the digitized signal is performed by the processing system 17, which as in the previous embodiment, may comprise one or more processors (CPU, DSP, etc.) and ancillary devices. The processor 17 is connected to a further hardware device 18, which may be arranged to perform compression of output data, and other functions, such as encryption, data shaping etc., in order to allow data to be sent from the local processing system 15 into the network 12. Furthermore, the processor 17 is connected to a local storage device 19, which is arranged to store local data (such as the raw sensor data and locally processed data). Data from the local storage device 19 may be retrieved upon request, and sent via the network 12.

The sensors 14 may comprise any kind of sensor useful in surveillance applications, e.g. a video camera, a microphone, switches, etc. A single sensor 14 may include more than one type of sensor, and provide e.g. both video data and audio data.

For surveillance applications, especially when used for large events covering a large geographical area, a lot of video data may be available from camera's located in the area. In known systems, all of the video data was observed by human operators, which requires a lot of time and effort. Improved systems are known, in which the video data is digitized, and the digitized video data is analyzed. However, such a system still requires a lot of human effort and time, especially when some analysis of the video data has to be repeated. Further improvements are known, e.g. from the publication US2003/0163289, in which object data is extracted from the video data, and events related to the object are detected (e.g. providing an alarm when a painting in a museum has suddenly disappeared. However, using known systems, it is still difficult and expensive to analyze a lot of surveillance data. It would be a tremendous advantage when more detailed searches could be performed in surveillance data without the necessity of spending more (computer and human) time. The ability of repeatedly searching surveillance data without the need to process the raw data over and over again is also highly desired.

In the surveillance method according to embodiments of the present invention, the full frame of video footage is used for object extraction, and not only a part of the footage (a region of interest), or only objects which generate certain predefined events, as in existing systems. Object detection is accomplished using motion, texture, and contrast in the video data. Furthermore, an extensive characterization of objects is obtained, such as color, dimension, shape, speed of an object, allowing more sophisticated classification (e.g. human, car, bicycle, etc.). Using the objects and the associated characteristics thereof, rules may be applied which implement a specific surveillance function. As an example, behavior rule analysis may be performed, allowing a fast evaluation on complete lists of objects, or a simple detection of complex behavior of actual objects. Furthermore, it is possible to implement a multi-role/multi-camera analysis, in which surveillance data may be used for different purposes using different rules. The analysis rules may be changed after a first video analysis, and new results may be obtained without requiring processing of the raw video data anew.

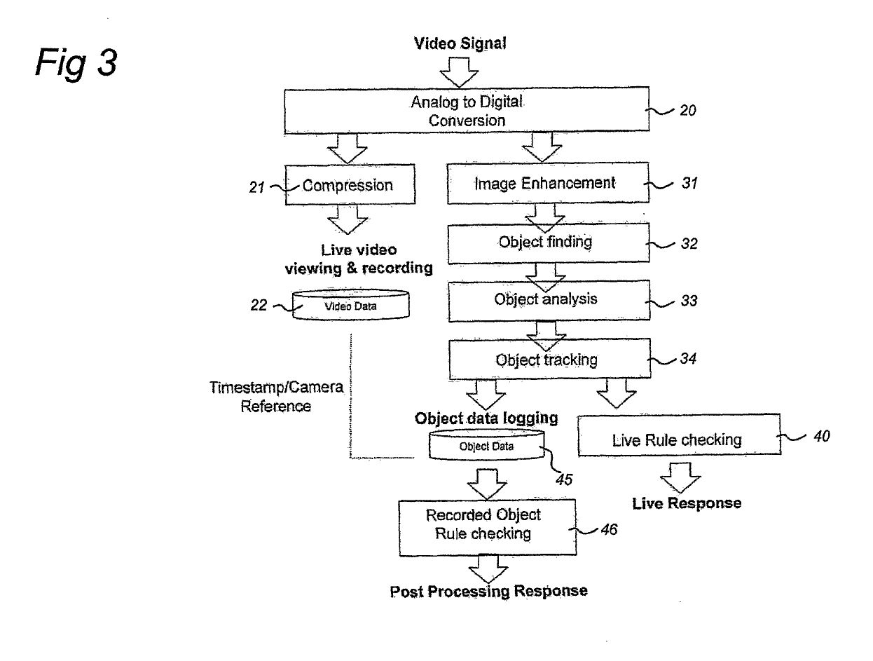

In FIG. 3 a functional flow diagram is shown of en embodiment of the surveillance method according to the present invention. The video signal from the sensor 14 is converted in a digital signal in block 20. The digitized video is further processed in two parallel streams. The left stream implements the necessary processing for live video review and recording of the video data. For this, the digitized video data is compressed in compression block 21, and then stored in a video data store 22. Advantageously, a lossless compression method is used, or a high quality compression technique such as MPEG4 coding, as this allows to retrieve all stored data in its original form (or at sufficient quality) at a later moment in time. The video data store may be part of the local storage device 19 as shown in the FIG. 2 embodiment, and may include time stamping data (or any other kind of referencing/indexing data). Stored video data may be retrieved at any time, e.g. under the control of the operator console 11, to be able to retrieve the actual imagery of a surveillance site.

The right stream in the flow diagram of FIG. 3 shows the functional blocks necessary to obtain object data from the surveillance video data. First, the video is enhanced using image enhancement techniques in functional block 31. Then, object are extracted or found in functional block 32. The found objects are then analyzed in functional block 33. In functional block 34, objects are tracked in the subsequent images of a video sequence. The object data output from the object tracking functional block 34 may be submitted to rules in a live manner in functional block 40. The object and associated data (characteristics, annotations), i.e. the extracted object list, are also stored in an object data storage 45 (e.g. the local storage device 19 as shown in FIG. 2, or a central storage device, e.g. part of the processing system 10 of FIG. 1). From this object data storage 45, data may be retrieved (e.g. using structured queries) by functional block 46, in which the recorded objects are submitted to rule checking. The rule set use predefined virtual objects, e.g. virtual fences/perimeters/lines in a video scenery, and the rules may use the mutual relationship of the virtual objects and the detected objects to provide predefined responses. The responses may include, but are not limited to providing warnings, activation of other devices (e.g. other sensors 14 in vicinity), or control of the sensors 14 in use (e.g. controlling pan-tilt-zoom of a camera).

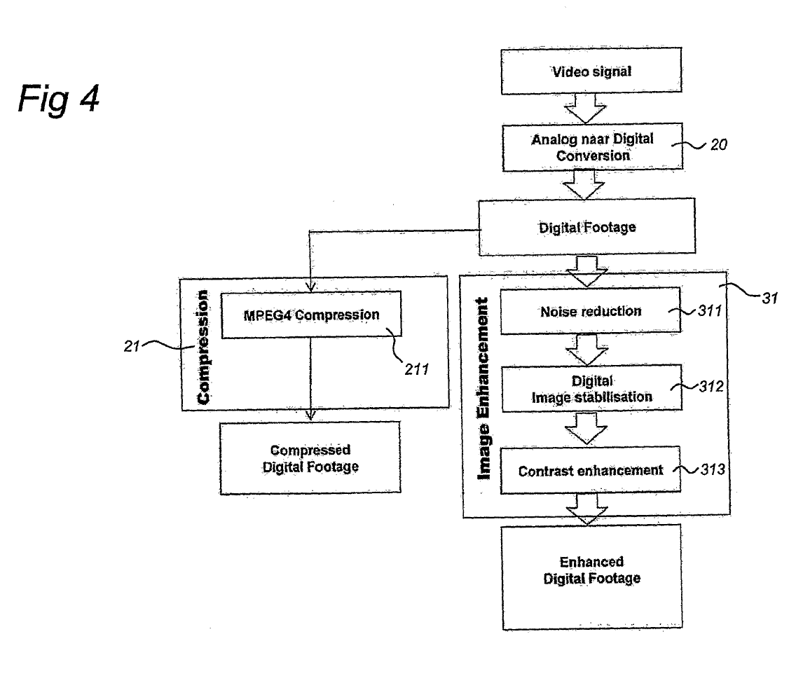

The functional blocks 21, 31-34, 40 and 46 are now explained in more detail with reference to the detailed functional block diagrams of FIGS. 4-9.

In FIG. 4, it is shown that the video signal is first converted into the digital domain in analog to digital conversion functional block 20. Analog to digital conversion of video signals (and signals from other types of sensors) is well known in the art. Various methods implemented in hardware, software or a combination of both may be used. In an exemplary embodiment, this results in a digitized video data stream with 25 frames/sec, corresponding to about 10 Mpixel/sec (or a 60 Mbit/s data rate). In a first stream, this digitized video data is compressed in compression functional block 21, e.g. using MPEG4 compression (block 211), resulting in a compressed digital footage of the surveillance site of 10 Mpixel/sec, but now reduced to 3 Mbit/sec. Compression may also be implemented using various combinations of hardware and/or software implementations, as known to the person skilled in the art. This compressed data stream may be used for live viewing of the video footage, but also for recording (locally or at a central location).

The image enhancement functional block 31 is shown in more detail on the right side of FIG. 4. First, the raw video data is subjected to a noise reduction in functional block 311, and then to a digital image stabilization functional block 312. Furthermore, the video data is subjected to a contract enhancement functional block 313. All the mentioned functions are known as such to the person skilled in the art, and again, the functional blocks 311-313 may be implemented using hardware and/or software implementations. It is noted that the video data is still at 10 Mpixel/sec and 60 Mbit/sec in the mentioned example, and that the functional blocks are arranged to allow processing of video data at such rates.

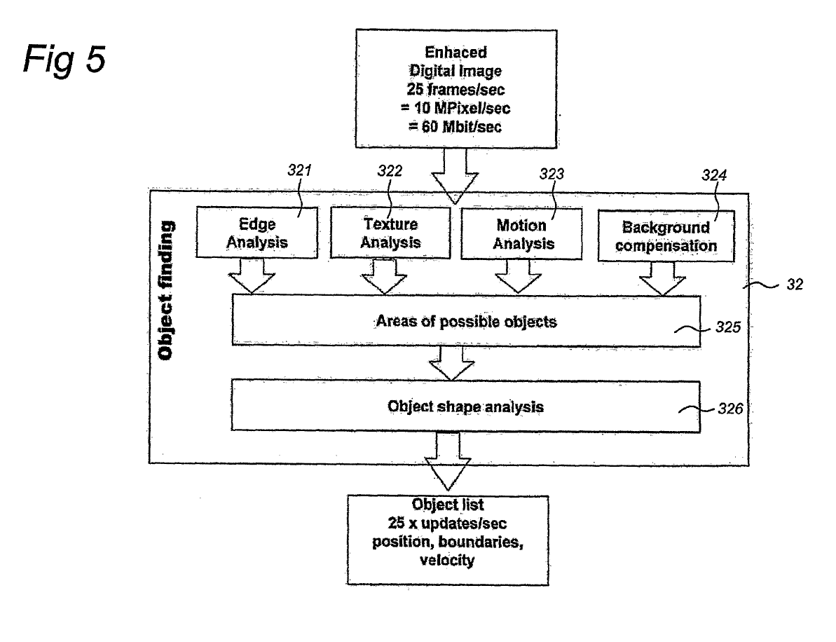

FIG. 5 shows the object finding functional block 32 in more detail. The video data is subjected to a number of functions or algorithms, which may include, but are not limited to, an edge analysis block 321 arranged to detect edges in the video data, a texture analysis block 322 arranged to detect areas with a similar texture, a motion analysis block 323 arranged to detect motion of (blocks) of pixels in subsequent images, and background compensation block 324 arranged to take away any possible disturbing background pixels. From all these functional blocks 321-324, areas of possible objects may be determined in functional block 325. For all the detected objects, furthermore an object shape analysis block 326 may be used to determine the shape of each object. The result of this object finding functional block 32 is an object list, which is updated 25 times per second in the example given. For each object, positions in the picture, boundaries and velocity is available. All the mentioned functions are known image analysis techniques as such, and again, the functional blocks 321-326 may be implemented using hardware and/or software implementations. It is noted that at this stage, the data information flow is already at a much reduced rate, i.e. orders of magnitude smaller than the original video data at 60 Mbit/sec.

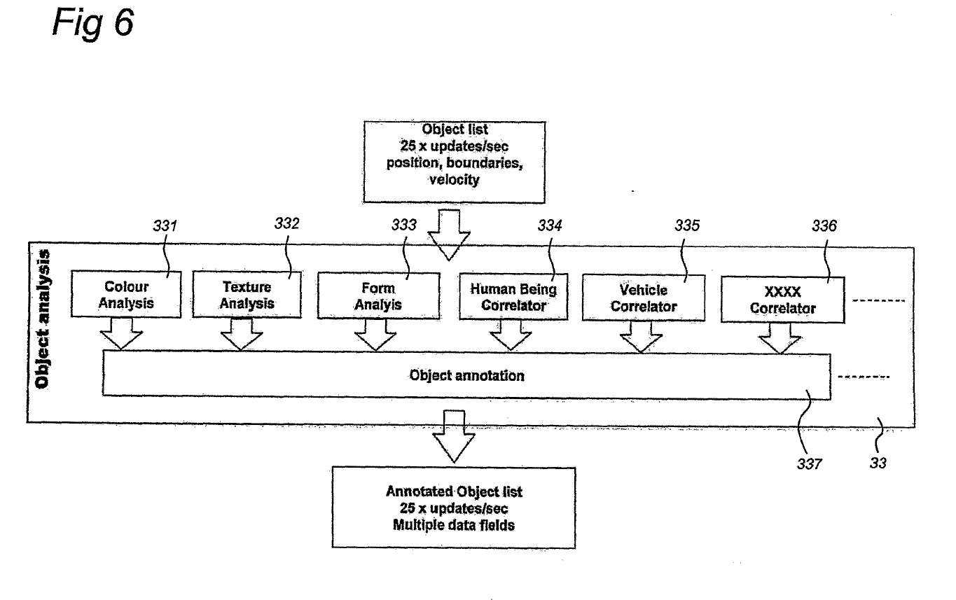

In FIG. 6, the object analysis functional block 33 is shown in more detail. From the object list with (in the given example) 25 updates/sec, a large number of characteristic features of each of the objects may be derived. For this a number of functional blocks are used, which again may be implemented in hardware and/or software. The (non-limitative) characteristics relate to color (block 331), texture (block 332), and form (block 333) analysis, and a number of correlator functional blocks. The human being correlator block 334 determines the chance whether an object is a human (with an output in e.g. a percentage score). Further correlation functional blocks indicated are vehicle correlator functional block 335, and further correlator functional block 336 (e.g. aircraft correlator). The output of these functional blocks is combined in object annotation functional block 337, in which the various characteristics are assigned to the associated object in an annotated object list.

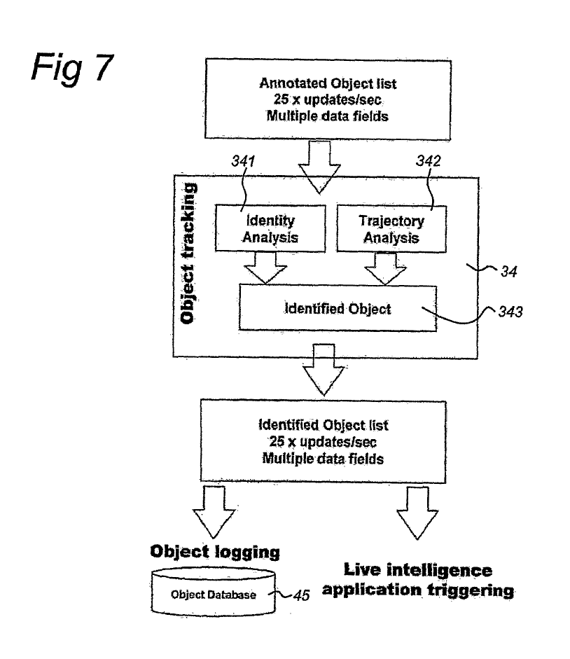

In FIG. 7, further details of the object tracking functional block 34 are shown schematically. In consecutive images or fields of the video data, or more specifically at this stage, in the consecutive updates of the annotated object list, an identity analysis and a trajectory analysis are performed in functional blocks 341, and 342, respectively. The output thereof is received by identified object functional block 343, which then outputs an identified (extracted) object list, which has an update rate of 25 updates/sec. The objects may then be stored or logged in the object database 45 as discussed above (e.g. an SQL database), or transferred to the liver rule checking function, indicated as live intelligence application triggering in FIG. 7.

The method as described above may be implemented for a single camera, but also for a large number of camera's and sensors 14. When multiple camera's are used, the rule checking output (Live Response, or Post processing response) may include more complex camera control operations, such as pan-tilt-zoom operations of a camera, or handover to another camera. The functions described above may in this case be implemented locally in the camera 14 (see exemplary embodiment of FIG. 20), such that each video stream is processed locally, and only the object data has to be transferred over the network 12.

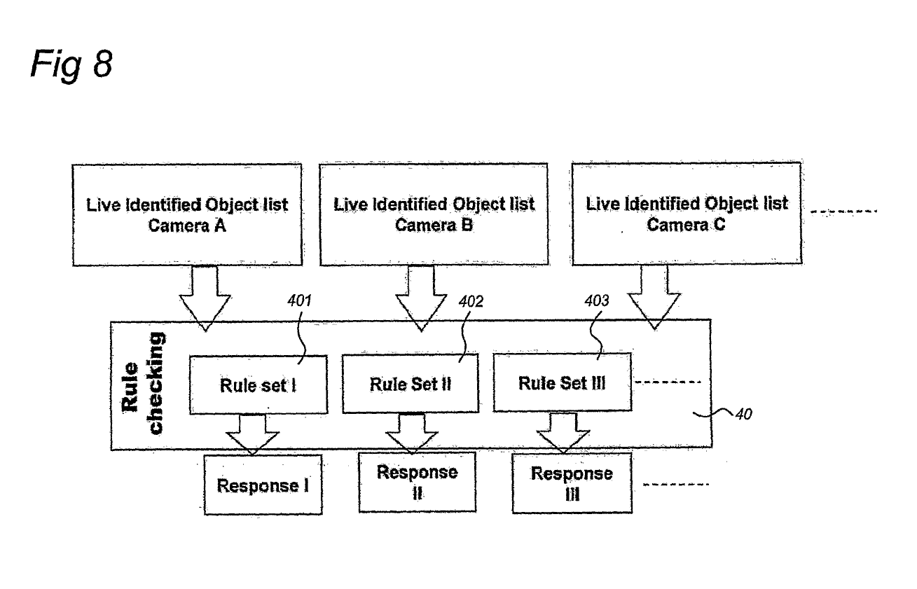

In FIG. 8, a more detailed schematic is shown of the rule checking functional block 40 of FIG. 3. Extracted object lists of all camera's 14 in the surveillance system are input (real-time) to the rule checking functional block 40. In this functional block 40, one or more rule set functional blocks 401-403 may be present, which each provide their associated response.

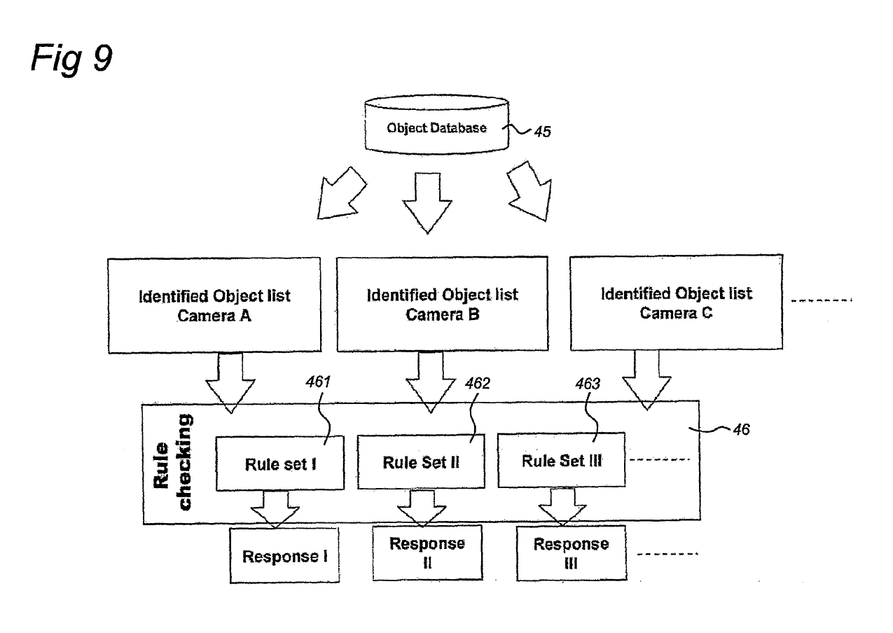

For the case of off-line video surveillance, e.g. for research implementations of recorded video footage, a structure as shown schematically in FIG. 9 may be used. The extracted object lists of each camera (A, B, C) are retrieved from the object database 45, and one or more rule sets may be applied to one or all of the object lists in functional blocks 461-463. Again, each rule set provides its own response.

Both in the live embodiment and in the off-line embodiment, the rule sets may be changed instantly (due to changing circumstances, or as a result of one of the rule sets), and the resulting response of the surveillance system is also virtually instantaneous. In the case of the off-line embodiment, the rule sets may be fine-tuned, and after each amendment, the same extracted object list data may be used again to see whether the fine-tuning provides a better result.

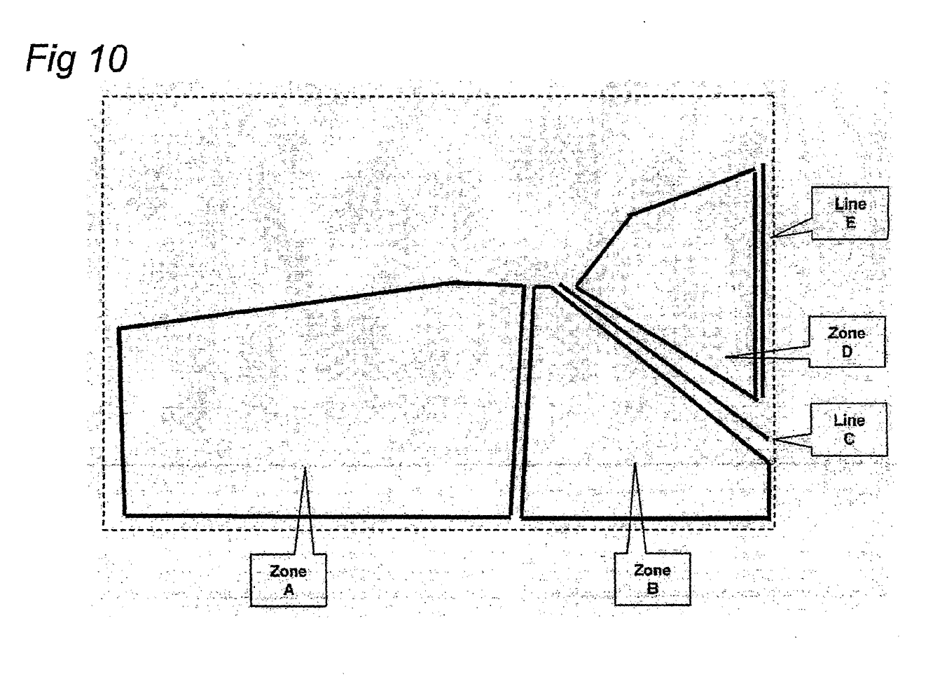

A number of possible set-ups of the surveillance system and method according to the present inventions are now discussed with reference to the schematic diagrams of FIGS. 10-12.

With reference to FIG. 10, a set-up and rule set is discussed for a virtual fencing system, which allows to detect an intruder. FIG. 10 shows a camera frame (indicated by dashed line) with virtual fences and virtual lines in an image from a video camera. In this example, on the right side of the picture (within zone E), a building is located at the actual surveillance site. The camera is viewing along a road (within zone A), which is bordered by a roadside (within zone B). Along the roadside, a trench is located, the middle of which is indicated by the virtual fence line C. At the border of the picture, a further virtual fence line E is located.

The rules applied in the live rule checking functional block 40 or in recorded object rule checking functional block 46, and possible responses, may look like:
Object X in public Zone A
   No suspect situation: public area
   Possible registration because of “hazard assessment”
Object X transits from Zone A to Zone B
   Possible intruder situation
   Pre-alert and close inspection
Object X transits from Zone B across Line C
   Object passes area border from outside: Intruder alert
Object X in Zone D
   Intruder in Zone D: Intruder alert
Object X disappears in Zone D
   Intruder behind vehicles in front of building: last position known
   Intruder disappears outside camera view, heading north-west
Object X transits from zone D over Line E
   Intruder transits from Zone D to area outside the camera view heading north-west

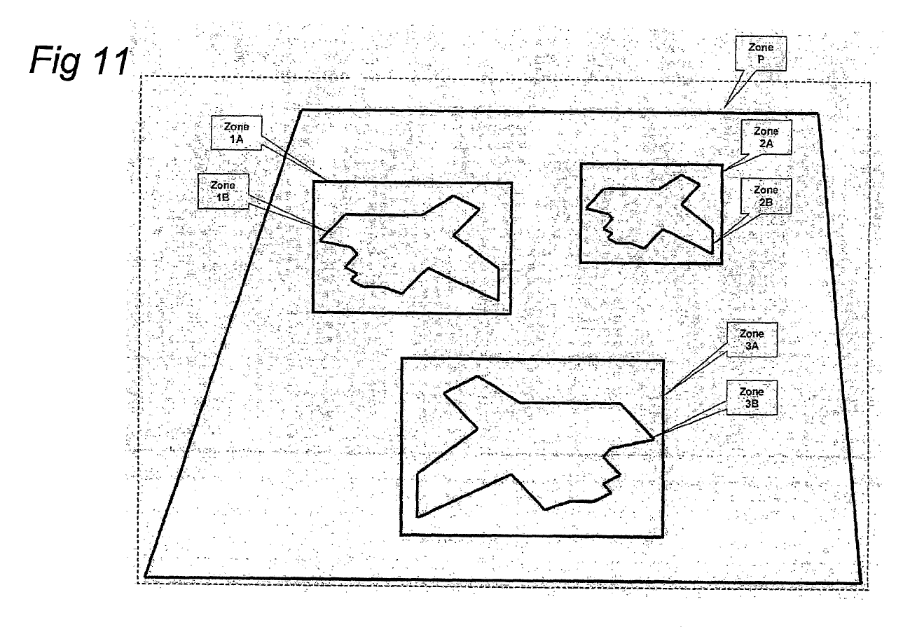

In FIG. 11, a further example is shown for a surveillance system in an airport environment. An aircraft parking zone on an airfield is indicated by the virtual fence Zone P inside a camera frame (indicated by dashed line). When a new object X is detected in Zone P, the following responses are executed: Wait until the object X stops; Identify as aircraft (according to shape and size of object X; After n minutes of standstill: apply virtual object fence zones A en B (indicated by Zone 1A, 2A, 3A, and 1B, 2B, 3B in FIG. 11 for three different objects); and After m minutes activate “Aircraft Security Rules” for Aircraft #.

The Aircraft Security Rules for each Aircraft # (# being 1, 2, or 3 in FIG. 11) on the aircraft parking zone may have the following form:
Object X in Zone #A
   Possible Intruder situation
   Pre-signaling and close PTZ inspection
Object X transits from Zone #A to Zone #B
   Object crosses security border from outside: Aircraft intruder alert
   Track object in Zone P with a PTZ (Pan-Tilt-Zoom) camera
Object X transits from Zone #B to Zone #A
   Object crosses security border from inside: Stowaway alert
   Track object in Zone P with PTZ camera

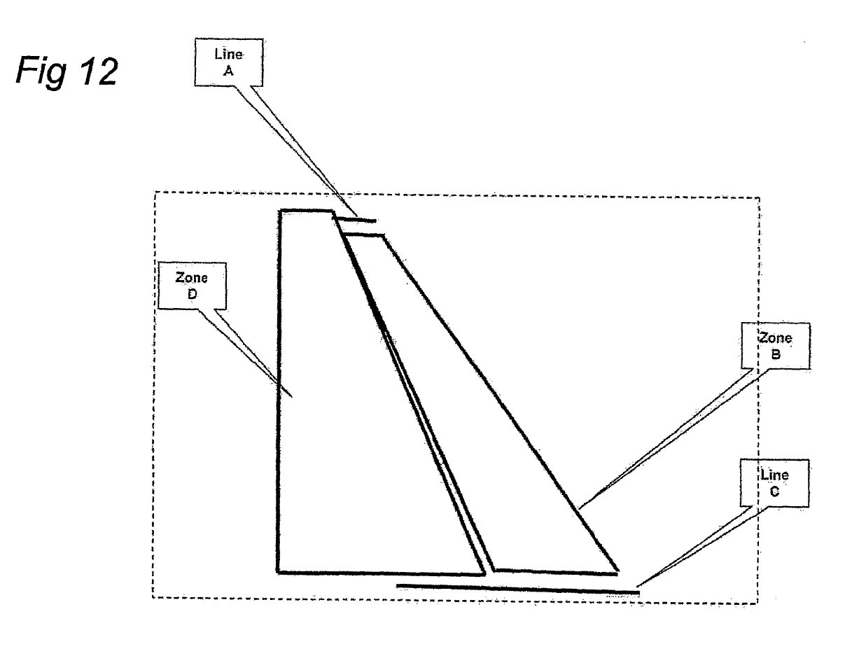

In a further example of rules which may be applied to objects extracted from video data, a view is shown in FIG. 12 with virtual fences for a traffic measurement and safety application. A roadside is located in the actual location, along which a number of parking spaces are provided, which scenery is viewed in a camera frame indicated by a dashed line. A virtual fence Zone B is raised on the roadside, and a virtual fence Zone D is raised around the parking spaces. Furthermore, a first line A is drawn across the road in the distance, and a second line C is drawn across the road nearer to the camera position. At the same time, a number of rules with different purpose may be set. A first rule set allows to assist in traffic management:
Object passes Line A and Line C
   Compute average speed from distance between the lines and the time interval (and register license plate when average speed is over limit)
Object(s) in Zone B stand still
   Pile up situation

A second rule set may be applied related to safety:
Object in Zone D
   Correlation with human shape>50% (human object detected)
   Motion up and afterwards down or Motion down, afterwards up (behavioural pattern of a person looking to break into one of the parked cars)
   Possible car burgler (after which a PZT-camera may be used to obtain detailed imagery of the burgler)

In the above embodiments, the sensors are chosen as providing video data. However, it is also possible to use other sensors, such as audio sensors (microphone), vibration sensors, which also are able to provide data which can be processed to obtain extracted object data. E.g. for sound data from a microphone, it may be determined that the extracted object is ‘breaking glass’, and further object annotations may be provided for proper rule checking, e.g. to allow to discern between a breaking glass bottle and a breaking glass window. A virtual object may e.g. be ‘Sound of braking glass’ and the rule may be: Object is ‘Sound of breaking glass’: then activate nearest camera to instantly view the scene.

1-15. (canceled)

16. Surveillance method for monitoring a location, comprising:
acquire sensor data from at least one sensor;
process sensor data from the at least one sensor, in order to obtain an extracted object list, the extracted object list comprising all objects in a sensor data stream;
and after an extracted object list is obtained:
define at least one virtual object; and
apply at least one rule set to the extracted object list, the at least one rule set defining possible responses depending on the extracted object list and the at least one virtual object.

17. Method according to claim 16, in which the extracted object list is updated depending on the update rate of the at least one sensor.

18. Method according to claim 16, in which the extracted object list is stored, and the at least one rule set is applied later in time.

19. Method according to claim 16, in which the at least one rule set comprises multiple, independent rule set.

20. Method according to claim 16, in which processing sensor data comprises determining for each extracted object in the extracted object list associated object attributes.

21. Method according to claim 16, in which obtaining the extracted object list comprises consecutive operations of data enhancement, object finding, object analysis and object tracking.

22. Method according to claim 21, in which the sensor data comprises video data, and the data enhancement comprises one or more of the following data operations:
noise reduction; image stabilization; contrast enhancement.

23. Method according to claim 21, in which object finding comprises one or more of the group of data operations comprising:
edge analysis, texture analysis; motion analysis; background compensation.

24. Method according to claim 21, in which object analysis comprises one or more of the group of data operations comprising:
colour analysis, texture analysis; form analysis; object correlation.

25. Method according to claim 21, in which object tracking comprises a combination of identity analysis and trajectory analysis.

26. Surveillance system comprising at least one sensor and a processing system connected to the at least one sensor, in which the processing system is arranged to execute the surveillance method according to claim 16.

27. Surveillance system according to claim 26, in which the processing system comprises a local processing system located in the vicinity of the at least one sensor, and a central processing system, located remotely from the at least one sensor, and in which the local processing system is arranged to send the extracted object list to the central processing system.

28. Surveillance system according to claim 26, in which the local processing system further comprises a storage device for storing raw sensor data or preprocessed sensor data.

29. Surveillance system according to claim 26, further comprising at least one operator console arranged for controlling the surveillance system.

30. Surveillance system according to claim 29, in which the at least one operator console comprises a representation device, which is arranged to represent simultaneously the sensor data, objects from the extracted object list and at least one virtual object in overlay.

31. Method according to claim 17, in which the extracted object list is stored, and the at least one rule set is applied later in time.

32. Method according to claim 17, in which the at least one rule set comprises multiple, independent rule set.

33. Method according to claim 18, in which the at least one rule set comprises multiple, independent rule set.

34. Method according to claim 17, in which processing sensor data comprises determining for each extracted object in the extracted object list associated object attributes.

35. Method according to claim 18, in which processing sensor data comprises determining for each extracted object in the extracted object list associated object attributes.
